(19) United States
(12) Patent Application Publication
(10) Pub. No.: US 2005/0016424 A1
(43) Pub. Date: Jan. 27, 2005

(54) Crop preparation apparatus

(76) Inventor: Kenneth J. Ellington, Montrose, GA (US)

Correspondence Address: LITMAN LAW OFFICES, LTD., P.O. BOX 15035 CRYSTAL CITY STATION, ARLINGTON, VA, 22215, US

(21) Appl. No.: 10/438,824

(22) Filed: May 16, 2003

(51) Int. Cl. A01C 5/00

(52) U.S. Cl. 111/52

(57) ABSTRACT

The crop preparation apparatus is directed to a soil preparation tool having a soil ripper implement with an upper and lower section, at least one set of rotary tilling claws, and a spreader. The soil preparation tool is typically combined with an implement frame attached to a tractor hitch. The rotary tilling claws are attached to a tilling shaft that is rotated by a power transmission system. The power transmission system may be driven by a power take off shaft attached to a tractor or any other suitable device such as a hydraulic motor, belt drive, or a chain and sprocket system. The soil preparation tool provides a substantially flat elongated seedbed suitable for seeding and/or fertilizing.

### BACKGROUND OF THE INVENTION

1. Field of the Invention

The present invention generally relates to soil preparation and crop preparation tools. More specifically, the present invention is drawn to an apparatus for preparing a ground for seeding and/or fertilizing.

2. Description of Related Art

It is well known that freshly planted crops find it very hard,to grow and prosper in compacted soil. Plant roots find it difficult to penetrate an overly compact soil in search of, for example, water and water-soluble compounds such as nitrates (a form of plant food). Crops are plants, and like all plants (and all living things) require water because water provides the solvent in which bio-molecules, such as enzymes, can function in their hydrated form. Crops that fail to acquire sufficient water die as critical plant proteins dehydrate and fail to function properly.

Nitrates provide nitrogen to plants. Nitrogen is a critical component of plant protein. A soil that is too compact to allow roots to penetrate the soil to reach water, and hence dissolved nitrates leads to stunted plant growth and reduced crop output. Crop farmers rely on high crop yields to cover costs and generate a profit to both feed and cloth the farmer and his/her family and also to pay for next year's seed. If crop yields drop, crop farmers suffer. Thus, there is a need to convert compacted soil into ripped and tilled soil in which plant roots can grow freely to seek out water and plant nutrients dissolved therein, such as nitrates. More particularly, there is a need to provide substantially flat and elongated seedbeds suitable for seeding and/or fertilizing to bolster crop production and thereby generate profits for the farmer.

Several efforts have been made to address these problems. U.S. Pat. No. 5,542,362, issued Aug. 6, 1996 to J. H. Bassett, describes an apparatus for continuously planting seed in subjacent soil. The '362 apparatus comprises several structures on a frame that separately move residue away from a row into which seed is to be deposited, part the soil to define a seed slot, deposit seed in the seed slot, and cover the seed with soil. The '362 device also includes a structure that applies an additive to the soil between the residue resituating structure and the seed depositing structure. The '362 apparatus does not teach or suggest the apparatus of the present invention, and more specifically does not teach a soil ripper, rotary tiller, and spreader combination for preparing ground for seeding as claimed in the present invention.

U.S. Pat. No. 5,461,993, issued Oct. 31, 1995 to Ikumoto, et al., describes an apparatus for seed sowing having a seed sower that travels on a ground surface while cutting a furrow with claw wheels. The '993 patent does not teach a soil ripper, rotary tiller, and spreader combination for preparing ground for seeding as claimed in the present invention.

U.S. Pat. No. 4,478,159, issued Oct. 23, 1984 to R. Melgoza, describes an apparatus for planting seed. The '159 device is used to seed a field that has a plurality of parallel beds of earth separated from each other by parallel furrows. Each of the beds of earth has a substantially flat, horizontal upper surface. The upper surfaces of the beds are disposed in substantially the same horizontal plane. More specifically, the '159 device is used to seed fields which have already been prepared with, for example, parallel beds and furrows. Thus, the '159 device does not rip, till and flatten the ground ready for seeding as disclosed and claimed in the present invention.

None of the above inventions and patents, taken either singly or in combination, is seen to describe the instant invention as claimed below. Thus, a crop preparation apparatus is desired.

### SUMMARY OF THE INVENTION

The present invention is directed to a soil preparation tool comprising a soil ripper implement with an upper and lower section, at least one set of rotary tilling claws, and a spreader. The soil preparation tool is typically combined with an implement frame attached to a tractor hitch. The rotary tilling claws are attached to a tilling shaft that is driven by a power transmission system. The power transmission system may be driven by a power take off shaft attached to a tractor or any other suitable device, such as a hydraulic motor, belt drive, or a chain and sprocket system. The soil preparation tool provides a substantially flat, elongated seedbed suitable for seeding and/or fertilizing.

The present invention is also directed to a method of preparing the substantially flat, elongated seedbed suitable for seeding and/or fertilizing, comprising the steps of: ripping the soil down to a depth of about fourteen to sixteen inches to provide ripped soil; nearly simultaneously tilling the ripped soil by means of at least one set of rotary tiller blades to provide ripped and tilled soil; and spreading the ripped and tilled soil by means of a spreader to achieve a substantially flat and elongated seedbed suitable for seeding and/or fertilizing.

Accordingly, it is a principal object of the invention to provide an apparatus to prepare ground for seeding.

It is another object of the invention to provide an apparatus for ripping, tilling and spreading soil to render the soil suitable for seeding and/or fertilizing.

It is a further object of the invention to provide a method of preparing a substantially flat, elongated seedbed suitable for seeding and/or fertilizing.

It is an object of the invention to provide improved elements and arrangements thereof in an apparatus for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a crop preparation apparatus according to the present invention.

FIG. 2 is a rear view of the crop preparation apparatus according to the present invention.

FIG. 3 is a fragmented rear elevation view of the crop preparation apparatus according to the present invention.

FIG. 3A is a fragmented rear elevation view of the crop preparation apparatus with two sets of claws in reverse orientation to that as shown in FIG. 3.

FIG. 3B is a fragmented rear elevation view of the crop preparation apparatus fitted with an optional tiller shaft protector device according to the present invention.

FIG. 4 is a side view of a soil preparation tool according to the present invention.

FIG. 5 is a side view of a soil ripper implement (i.e. a shank) according to the present invention.

Similar reference characters denote corresponding features consistently throughout the attached drawings.

### DETAILED DESCRIPTION OF THE PREFERRED EMBODIMENTS

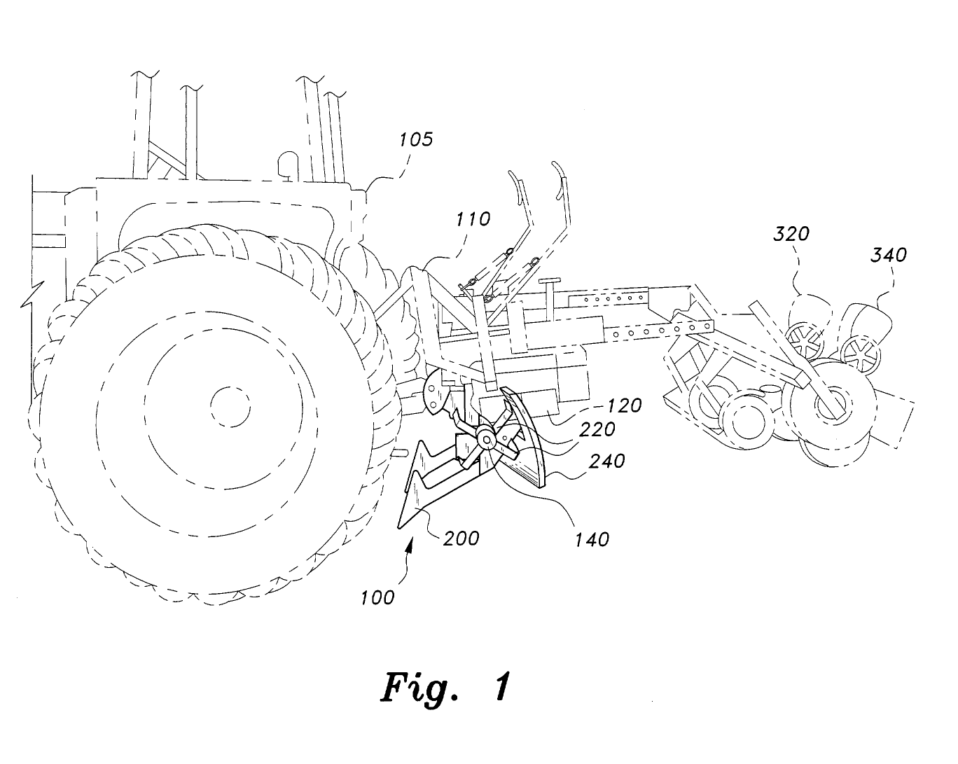

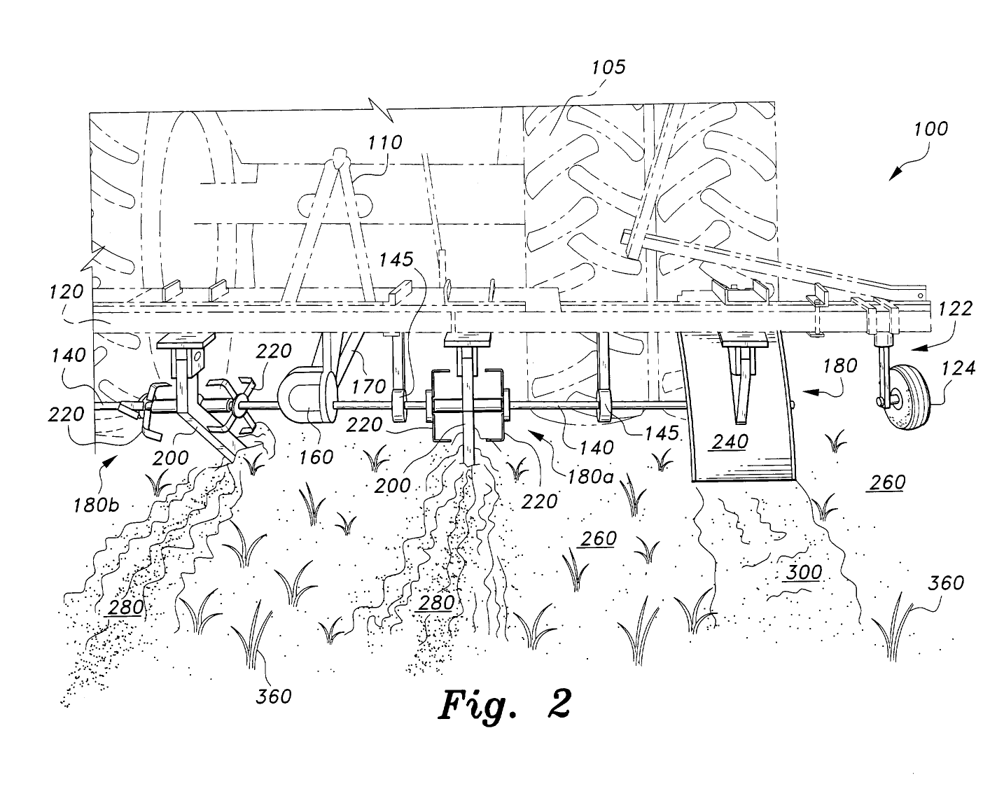

Referring to the FIGS. 1-5 generally, the crop preparation apparatus 100 comprises an implement frame 120, a tilling shaft 140, a power transmission mechanism 160 adapted to transmit rotational mechanical energy to the tilling shaft 140, and at least one soil preparation tool 180 connected to the implement frame 120. At least one journal 145 supports the tilling shaft 140 as shown in FIG. 2. The journal 145 is preferably fitted with a bearing to allow the tiller shaft to rotate freely. The implement frame 120 can be any framework design suitable for holding the at least one preparation tool 180, e.g. the framework 120 may comprise a lattice for attaching the at least one preparation tool 180. A lattice structure has crossed metal strips and would enable the implement frame 120 to absorb shocks resulting from e.g., an accidental collision between a soil ripper implement 200 and a rock or stump in the soil 260.

The soil preparation tool 180 comprises a soil ripper implement 200 (i.e., shank 200, the terms “shank” and “soil ripper implement” are hereinafter regarded as equivalent terms), tilling claws 220 and a spreader 240, wherein the tilling claws 220 are connected to the tilling shaft 140 and undergo rotation in response to rotation in the tilling shaft 140. The ripper implement 200 rips the ground, and more particularly the soil 260, proximate but upstream to the tilling claws 220. The tilling claws 220 till the top surface of the ripped soil to generate ripped and tilled soil 280 (see FIG. 2). The spreader 240 limits the spread of soil 280 disturbed by the tilling claws 220.

The ripper 200 and claws 220 nearly simultaneously rip and till the soil 260 and thereby mix the soil 260 with plant residue, such as grass 360, found on the soil surface to provide ripped and tilled soil 280. The utility of the ripper and claws 220 combination is best seen in the left and center furrows of FIG. 2, in which two of the soil preparation tools 180a and 180b each lack the spreader member 240. Lacking a spreader 240, the tools 180a and 180b produce ripped and tilled soil 280. The complete soil preparation tool 180, i.e. comprising a spreader 240, renders the ripped and tilled soil 280 to a substantially flat elongated seedbed 300, as shown in the furrow in the right side of FIG. 2, suitable for seeding and/or fertilizing by a seeder member 320 and/or fertilizer member 340, as shown in FIG. 1. located downstream of the crop preparation apparatus 100.

It should be understood that the term “flat” within the term “substantially flat elongated seedbed” does not preclude a seedbed prepared by the apparatus in a field with a gradient, e.g. a field on a hillside. The spreader 240 renders the otherwise ripped and tilled soil 280 into a substantially flat elongated seedbed 300 suitable for seeding.

Still referring to FIGS. 1 and 2, the crop preparation apparatus 100 is attached to a farm vehicle, such as a tractor 105. A hitch, such as a three-point hitch 110, can attach the crop preparation apparatus 100 to the tractor 105. In addition, the opposite ends of the implement frame 120 may terminate in a frame support mechanism 122, which preferably includes an adjustable height wheel 124, best seen in FIG. 2, to help maintain the implement frame 120 at a desired height above the soil 260.

A power take off shaft 170 connects the power transmission mechanism 160, which may comprise a gearbox, to a power take off driving means (not shown). Power take off mechanisms are well known in the art and will not be described further. It should be understood that the tilling shaft 140 can be rotated by any suitable device such as a hydraulic motor, belt drive, or a chain and sprocket system.

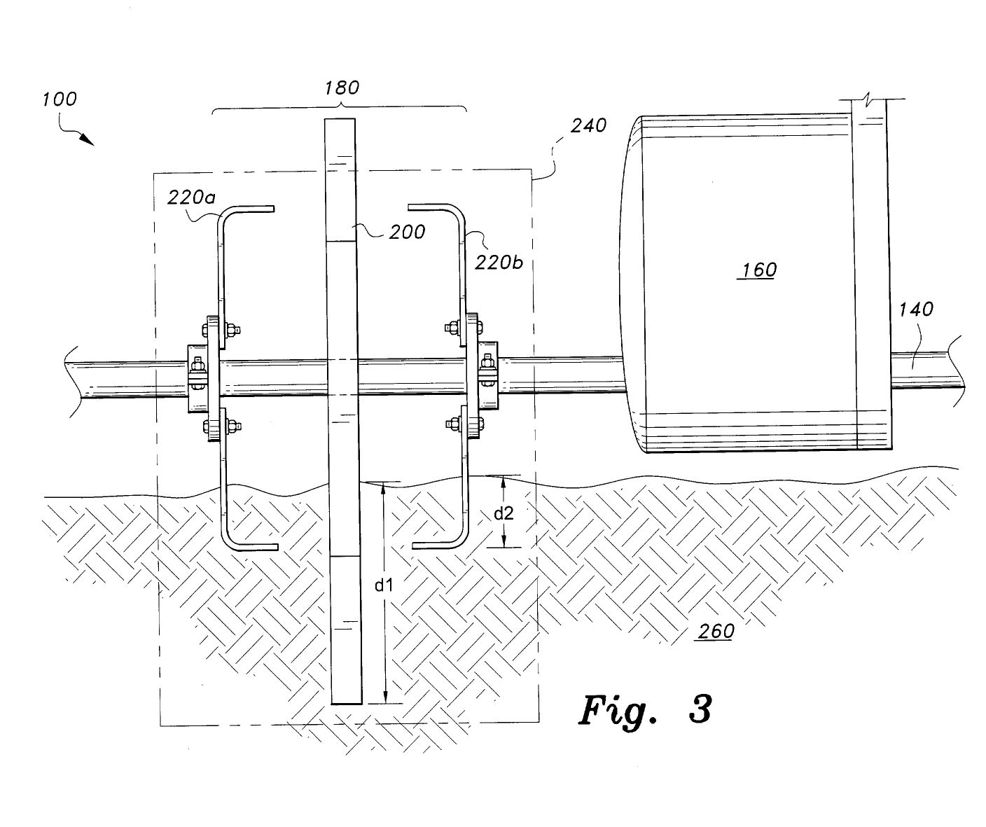

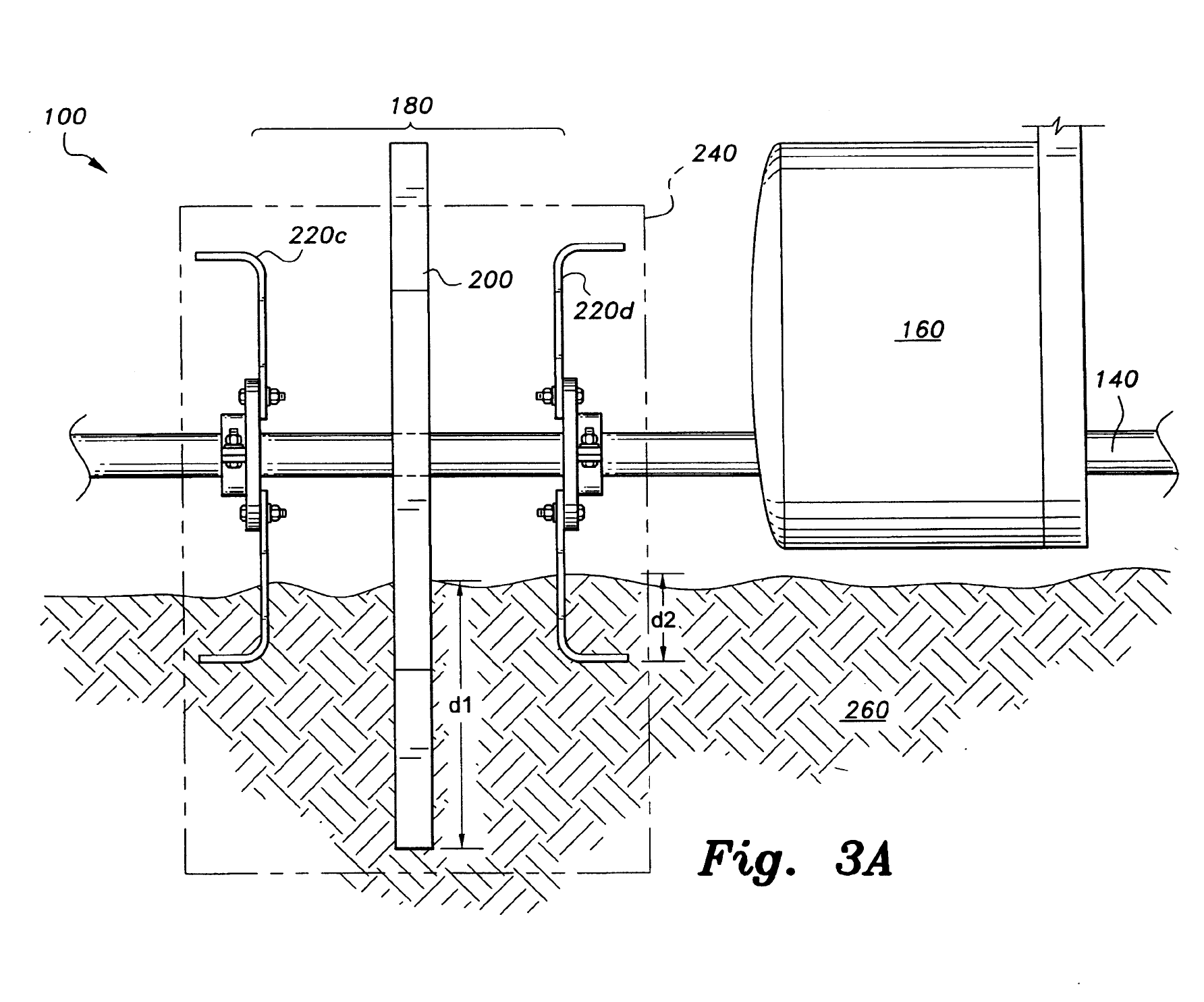

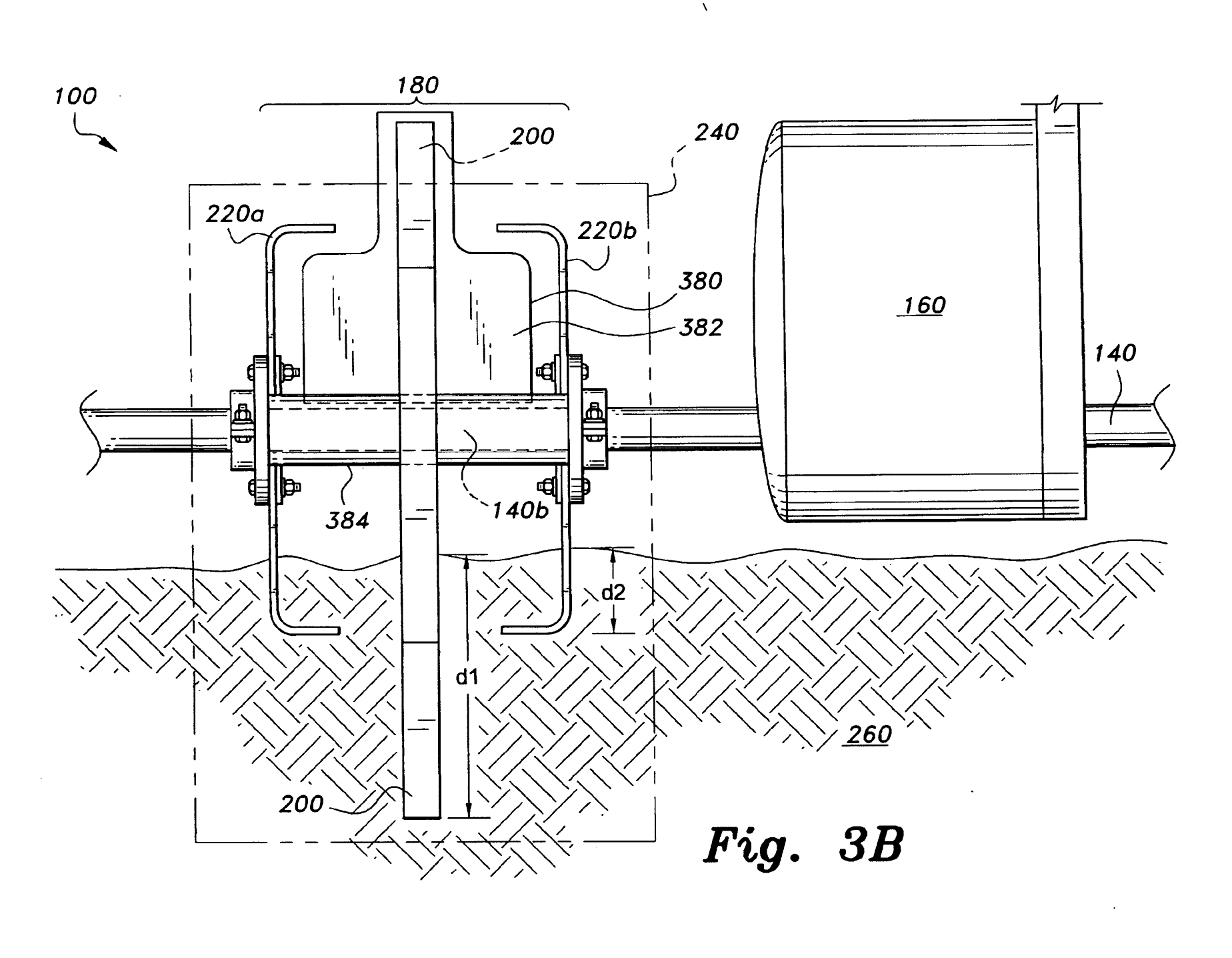

FIG. 3 is a close up rear view of a crop preparation apparatus 100 with the spreader member 240 shown in phantom in order to reveal the internal arrangement of the claws 220 (shown as claws 220a and 220b) and shank 200. A first set of claws 220a are shown on one side of the shank 200 and a second set of claws 220b are shown on the other side of the shank 200. The shank 200 rips the soil 260 to a depth of about fourteen to sixteen inches (shown as “d1” in FIG. 3). The claws 220a and 220b till the soil 260 to a depth of about three to four inches (shown as “d2” in FIG. 3). It should be understood that the claws 220 may vary in their exact arrangement without detracting from the spirit of the claimed invention herein; for example, in FIG. 3A the claws 220 (shown as claws 220c and 220d) are shown in reverse orientation on the shaft 140 as compared to the claws 220a and 220b of FIG. 3.

FIG. 3B is a close up rear view of a crop preparation apparatus 100 with the spreader member 240 in phantom showing the arrangement of a tiller shaft protector 380 or shield according to the present invention. The tiller shaft protector 380 comprises a plate 382 connected to a hollow tube 384. The hollow tube 384 surrounds a segment of the tiller shaft 140 (shown as segment 140b in FIG. 3B), wherein the segment 140b is located between the tilling claws 220a and 220b, whereby the hollow tube 384 (and hence the tiller shaft protector 380) protects the shaft segment 140b (and hence shaft 140) from soil and detritus thrown up by the tilling claws 220a and 220b. Thus, the tiller shaft protector 380 helps prevent jams and/or damage to the tiller shaft 140 during operation of the crop preparation apparatus 100.

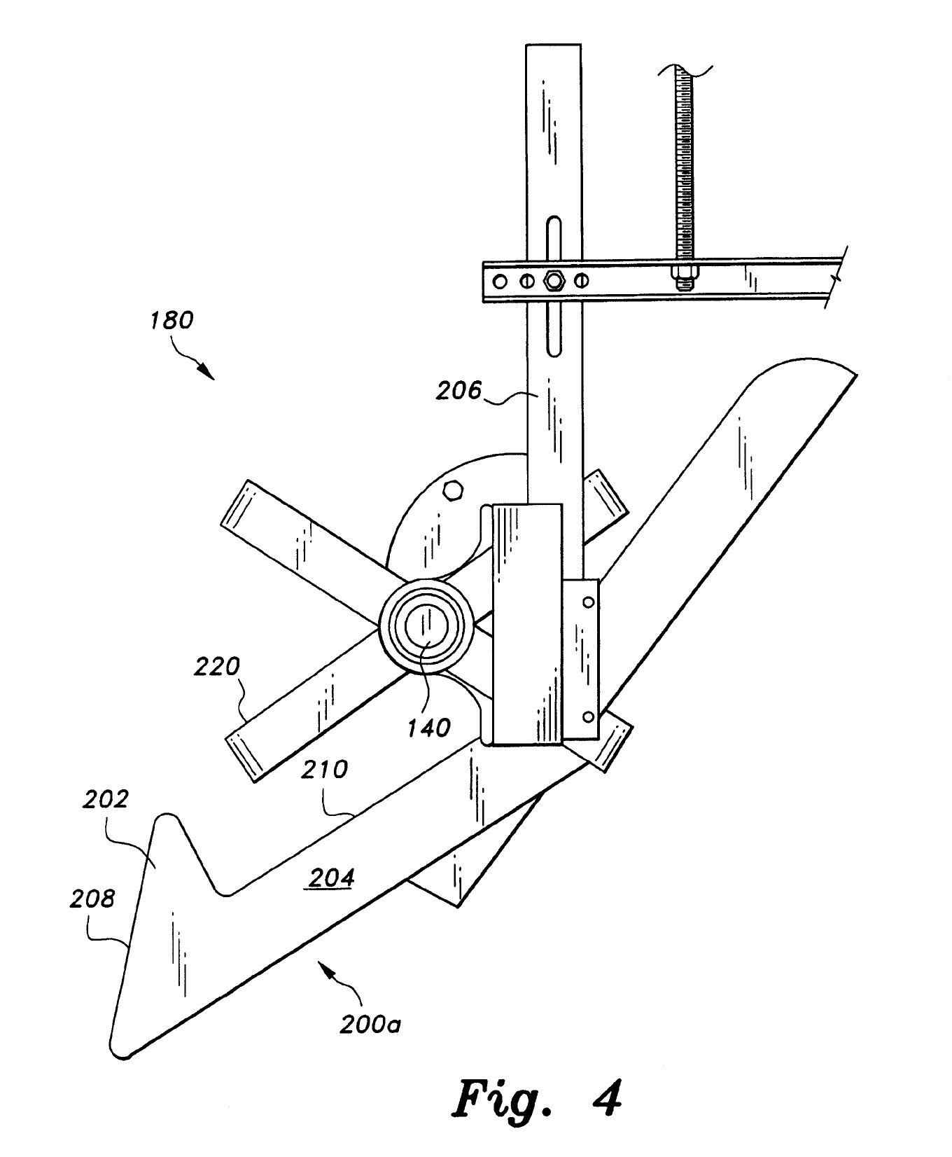

FIG. 4 is a side view of a soil preparation tool 180 according to the present invention (spreader 240 not shown). The soil ripper implement 200a comprises a shank foot 202 (at the lower end of the shank 200a), a shank stem 204, and a shank depending arm 206. The shank foot 202 defines a first leading edge 208, and the shank stem 204 defines a second leading edge 210. The leading edges 208 and 210 normally face the soil 260 leading edge on.

The shank 200 (including shanks 200a and 200b) can be any suitable thickness, e.g., about one inch. The shank foot 202 is extremely effective at tilling (i.e. ripping) the soil 260, thus the wear on the shank foot 202 can be severe. For this reason, it is preferred that the first leading edge 208 is made of a hard material that is resistant to wear.

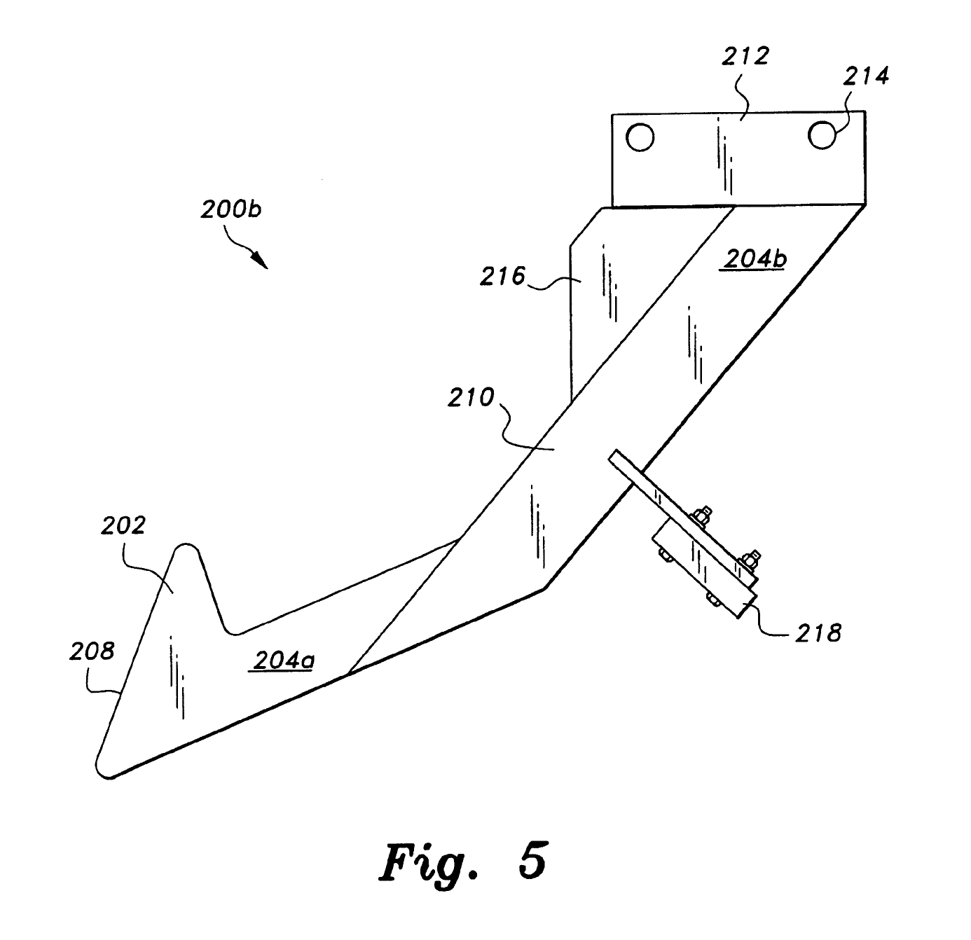

FIG. 5 is a side view of a further embodiment of the soil ripper implement 200 (shown as “200b”) according to the present invention. The shank 200b differs from the shank 200a in a number of respects. For example, the stem 204 of shank 200a of shank 200a is split into two sections: a lower stem section 204a and an upper stem section 204b. In addition, the shank 200b lacks a depending arm 206, but the stem 204 terminates in a connecting plate 212 with at least one bolthole 214 that can be used to bolt the shank 200b to the implement frame 120 (not shown).

Still referring to FIG. 5, the shank 200b comprises an optional reinforcing gusset plate 216 of approximately triangular shape. The plate 216 reinforces the connection between the stem 204b and the connecting plate 212 and thereby helps prevent mechanical separation between the stem 204 and the plate 212. An optional soil firming attachment 218 is fitted to the stem section 204b. The optional soil firming attachment 218 can be fitted to the shank 200b (or any functionally equivalent shank 200 such as shank 200a) when the shank 200b is used in soil in which the shank 200b causes more ripping of the soil 260 than desired.

The shank 200, and in particular the shank foot 202 and leading edge 210, can collide with hard items such as a rock or stump that might be found in the soil 260. Thus, it is important that the shank 200 can withstand the stresses involved in such collisions by flexing accordingly without shearing or breaking prematurely. Because of the threat of collisions between rocks in the soil 260 and the lower sections of the shank 200, the tiller shaft 140 should be positioned in front of the depending arm 206 (FIG. 4) or the upper stem section 204b.

If the tiller shaft 140 is located in front (i.e., up stream) of the upper sections of the shank 200 there is less chance of the shank 200 hitting the tiller shaft 140 in response to a collision between a lower section of the shank 200 and a rock, or another hard object, in the soil 260. In contrast, if the tiller shaft 140 was mounted immediately behind (and hence immediately down-stream) of the upper sections of the shank 200 there would be a strong possibility that the upper sections of the shank 200 would hit and damage the tiller shaft 140 in response to contact between the lower sections of the shank 200 and a hard object like a rock, stump, or unexpected hard ground.

The present invention is also directed to a method of providing a substantially flat, elongated seedbed suitable for seeding and/or fertilizing, comprising the steps of: ripping the soil down to a depth of about fourteen to sixteen inches to provide ripped soil; nearly simultaneously tilling the ripped soil by means of at least one set of rotating tiller blades to provide ripped and tilled soil; and spreading the ripped and tilled soil by means of a spreader to achieve a substantially flat and elongated seedbed suitable for seeding and/or fertilizing.

It is to be understood that the present invention is not limited to the sole embodiments described above, but encompasses any and all embodiments within the scope of the following claims.

1. A soil preparation tool comprising:
a soil ripper implement having an upper and lower section;
at least one set of tilling claws; and
a spreader;
wherein the lower section of the ripper implement is capable of ripping up soil ahead of the at least one set of tilling claws;
wherein the at least one set of tilling claws are adapted to rotate in response to a rotating force and thereby till a top soil in close proximity to the ripper implement; and
wherein the spreader is capable of limiting the spread of soil disturbed by the at least one set of tilling claws and spreading the ripped and tilled soil to achieve a substantially flat and elongated seedbed suitable for seeding and/or fertilizing.

2. A crop preparation apparatus comprising:
an implement frame;
a tilling shaft;
a power transmission mechanism adapted to transmit rotational mechanical energy to the tilling shaft; and
at least one soil preparation tool connected to the implement frame, the soil preparation tool comprising a soil ripper implement, tilling claws and a spreader, wherein the tilling claws are connected to the tilling shaft and undergo rotation in response to rotation in the tilling shaft;
whereby the ripper implement rips up the soil ahead of the tilling claws, and the tilling claws tills the top surface of the soil; and
whereby the spreader limits the spread of soil disturbed by the tilling claws, and spreads the ripped and tilled soil to achieve a substantially flat elongated seedbed suitable for seeding and/or fertilizing.

3. The crop preparation apparatus according to claim 2, wherein the power transmission mechanism is a gearbox is an integral part of the tilling shaft.

4. The crop preparation apparatus according to claim 2, wherein the power transmission mechanism comprises a pulley and belt drive mechanism.

5. The crop preparation apparatus according to claim 2, wherein the power transmission mechanism comprises a sprocket and chain drive mechanism.

6. The crop preparation apparatus according to claim 2, wherein the power transmission mechanism is driven by a power take off shaft leading from a tractor.

7. The crop preparation apparatus according to claim 2, wherein the power transmission mechanism is a hydraulic drive, and wherein the hydraulic drive is operative when appropriately connected to a tractor capable of powering the hydraulic drive.

8. The crop preparation apparatus according to claim 2, wherein the implement frame is hitched to a tractor.

9. The crop preparation apparatus according to claim 2 further comprising a tiller shaft protector fitted around a segment of the tiller shaft, wherein the segment is in close proximity to the tilling claws, whereby the tiller shaft protector protects the shaft from soil thrown up by the tilling claws.

10. The crop preparation apparatus according to claim 2, wherein the soil ripper implement further comprises a soil compacter member, whereby the soil compacter member is positioned on the ripper implement to facilitate packing the soil after tilling by the tiller claws.

11. The crop preparation apparatus according to claim 2 further comprising a seeder located downstream of the crop preparation apparatus.

12. The crop preparation apparatus according to claim 2 further comprising a seeder and a fertilizer apparatus located downstream of the crop preparation apparatus.

13. A method of providing a substantially flat, elongated seedbed suitable for seeding and/or fertilizing, comprising the steps of:
ripping soil down to a depth of about fourteen to sixteen inches to provide ripped soil;
nearly simultaneously tilling the ripped soil by means of at least one set of rotating tiller blades to provide ripped and tilled soil; and
spreading the ripped and tilled soil by means of a spreader to provide a substantially flat and elongated seedbed suitable for seeding and/or fertilizing.
